(19) United States
(12) Patent Application Publication
(10) Pub. No.: US 2019/0263228 A1
(43) Pub. Date: Aug. 29, 2019

(54) ROLLER SHUTTER FOR AUTOMOBILE

(71) Applicant: Foshan Palushi Automobile Accessories Co., Ltd, Foshan (CN)

(72) Inventor: Jianchang Zeng, Foshan (CN)

(21) Appl. No.: 16/406,035

(22) Filed: May 8, 2019

Related U.S. Application Data
(63) Continuation of application No. PCT/CN2018/104270, filed on Sep. 6, 2018.

(30) Foreign Application Priority Data
Dec. 3, 2017 (CN) 201721657523.9
Dec. 3, 2017 (CN) 201721658138.6
Apr. 17, 2018 (CN) 201820547132.X
Apr. 17, 2018 (CN) 201820547182.8
Apr. 17, 2018 (CN) 201820547184.7
Apr. 17, 2018 (CN) 201820547185.1
Apr. 17, 2018 (CN) 201820547693.X

(51) Int. Cl. B60J 1/20

(52) U.S. Cl. CPC B60J 1/2013; B60J 7/085

(57) ABSTRACT

The present invention discloses a roller shutter for an automobile, comprising guide slots, a roller shutter, a lock catch assembly locked with the guide slots, a rolling and unrolling assembly, a plurality of groups of pre-positioning installation assemblies and locking assemblies. Compared with the prior art, the roller shutter for an automobile enables the two guide slots to keep parallel through the pre-positioning installation assemblies and the positioning and locking assemblies during the assembling of the roller shutter. Because the switching process of the roller shutter is smoother at the connection between the roller shutter and the guide slots, more labor is saved. A guide turntable enables the roller shutter to slide through frictional force with the slots of the roller shutter, rolling and unrolling become smooth. The lock catch assembly can lock and position the roller shutter at any time, flexibility is strong and freedom is high.

### CROSS REFERENCE TO RELATED APPLICATIONS

The present application is a Continuation Application of PCT Application No. PCT/CN2018/104270 filed on Sep. 6, 2018, which claims the benefit of Chinese Patent Application Nos. 201820547184.7, 201820547132.X, 201820547693.X, 201820547182.8 and 201820547185.1 filed on Apr. 17, 2018, and Chinese Patent Application Nos. 201721658138.6 and 201721657523.9 filed on Dec. 3, 2017. All the above are hereby incorporated by reference.

### TECHNICAL FIELD

The present invention relates to the technical field of a roller shutter for an automobile, and in particular to a roller shutter for an automobile.

### BACKGROUND

A roller shutter is widely applied. Especially in the field of automobiles, the roller shutter can be used on the automobile to block an automobile compartment, to keep out the sun and rain. The roller shutter on the automobile is generally fixed to a frame through guide slots. In the process of installing the roller shutter, two guide slots are easy to imbalance in installation due to the fixation problem. Even if the two guide slots of the roller shutter are slightly offset, the pulling-out of the roller shutter will be affected. The frictional force produced in the process of unrolling or rolling of the roller shutter is large, and the user needs to take great effort in switching. Moreover, because the frictional force is large, noise will be generated in the switching process. There is also another roller shutter for an automobile. Bearings are installed on each roller shutter plate on both sides of the roller shutter, and roll inside the guide slots. Such automobile uses the roller shutter. Although the frictional force is relatively reduced in the switching process, the cost of the roller shutter is greatly increased due to high cost of the bearings and large quantity of bearings on the roller shutter. When one bearing is damaged, the use of the whole roller shutter will be affected. Moreover, the existing roller shutter can only be fully opened or fully closed. When the roller shutter is pushed away half, if the roller shutter is released, it is easy to unroll, which may easily hurt the user.

### SUMMARY

The purpose of the present invention is to solve the problems of the prior art and provide a roller shutter for an automobile having functions of locking and arbitrary positioning.

To realize the above-mentioned purpose, the present invention adopts the technical solution: a roller shutter for an automobile, comprising guide slots arranged on both sides of a frame, a roller shutter that slides between the two guide slots, a lock catch assembly arranged on the roller shutter and locked with the guide slots on both sides, a rolling and unrolling assembly for rolling and unrolling the roller shutter, a plurality of groups of pre-positioning installation assemblies used for enabling the two guide slots to keep parallel and positioning and locking assemblies used with the pre-positioning installation assemblies and connecting the guide slots with the frame.

Each guide slot extends downward and has a connecting wall; the guide slot is connected with a connecting plate arranged on the frame through the connecting wall; a slide rail is arranged in the guide slot; the roller shutter is formed by mutually connecting a plurality of roller shutter plates; rubber slots are arranged on the left side and the right side of each roller shutter plate; left and right roller shutter plates are connected through rubber strips adapted with the rubber slots; the bottom surface of each roller shutter plate is arched upward to form an arc; both sides of the arc bottom surface are in linear contact with the slide rail; and the roller shutter slides on the slide rail through the arc bottom surface which is in linear contact with the slide rail through each roller shutter plate.

The pre-positioning installation assemblies comprise a positioning ruler used for enabling the front distance and the rear distance of the two guide slots to be equal, and a regulating bolt for keeping the two guide slots parallel; a regulating hole adapted with the regulating bolt is formed in the connecting wall; the length of the positioning ruler is adapted with the width of the roller shutter; the regulating bolt on each guide slot penetrates through the regulating hole and spins on the connecting plate on the frame.

The positioning and locking assemblies comprise a front fixing component, a rear fixing component and a locking bolt; locking screw holes are formed in the front fixing component and the rear fixing component; the front fixing component, the connecting wall, the connecting plate and the rear fixing component are arranged in sequence; the regulating bolt penetrates through the connecting wall and spins on the connecting plate; the locking bolt penetrates through the locking screw holes in the front fixing component and the rear fixing component so that the front fixing component and the connecting wall are locked together, the rear fixing component and the connecting plate are locked together and the front fixing component and the rear fixing component are locked together.

The rolling and unrolling assembly comprises a roller shutter box, a first turntable, a second turntable, a fixing hole, a bayonet lock, a roller shutter slot and a roller shutter slot inlet; one end of the roller shutter box is provided with the first turntable, and the other end of the roller shutter box is provided with the second turntable; the roller shutter box is provided with the roller shutter; the first turntable and the second turntable are provided with the roller shutter slot; one end of the roller shutter slot is provided with the roller shutter slot inlet; the bayonet lock and the fixing hole are arranged around the first turntable and the second turntable; and the first turntable and the second turntable are fixed to the roller shutter box through the fixing hole and the bayonet lock.

As an improvement of the present invention, the roller shutter comprises first roller shutter plates, second roller shutter plates, a roller shutter hinge, a rubber slot and a rubber strip; the roller shutter is provided with a plurality of the first roller shutter plates and the second roller shutter plates; the first roller shutter plates are connected with the second roller shutter plates through the roller shutter hinge; the rubber slot is arranged between the first roller shutter plates and the second roller shutter plates; and the rubber slot is provided with the rubber strip.

As an improvement of the present invention, slide blocks are arranged on the front side and the rear side of each roller shutter plate; the bottom surfaces of the slide blocks are arc surfaces adapted to the arc bottom surfaces of the roller shutter gates; and the roller shutter slides on the slide rail of the guide slot through the slide blocks arranged on each roller shutter plate.

As an improvement of the present invention, each slide block is provided with a connecting block; each roller shutter plate is provided with a connecting hole; the connecting block of the slide block is clamped into the connecting hole and the bottom surface of the slide block is bucked on the bottom surface of the roller shutter plate; the upper surface of the bottom surface of the slide block is provided with a clamping block; and the roller shutter plate is provided with a clamping groove adapted with the clamping block.

As an improvement of the present invention, the front end and the rear end of each guide slot are provided with at least two regulating bolts; the regulating bolt on each guide slot is symmetrical with the regulating bolt on the other guide slot; and every two regulating bolts are used with one positioning and locking assembly.

As an improvement of the present invention, the front fixing component is arranged between two regulating bolts.

As an improvement of the present invention, the front fixing component and the rear fixing component are in L shape; and when the front fixing component and the rear fixing component are locked, the rear fixing component is pressed on the front fixing component.

As an improvement of the present invention, the lock catch assemblies are two spring locks with lock hooks symmetrically arranged on both sides of the front end of the roller shutter; and lock bodies of the spring locks are pressed so that the lock hooks can extend to the guide slots and fasten with the lower surfaces of the guide slots or release the guide slots and keep away from the lower surfaces of the guide slots.

As an improvement of the present invention, the lock hooks are provided with rubber columns.

As an improvement of the present invention, the lock catch assemblies are arranged on the roller shutter through lock boxes adapted with the lock bodies of the spring locks; installing holes are formed in the bottoms of the lock bodies of the spring locks; and the lock boxes are provided with assembling holes adapted with the installing holes.

As an improvement of the present invention, the upper surface of the roller shutter is provided with a lock box cover for bucking the lock bodies inside; the lock box cover is divided into a box frame and an upper cover pivoted with the box frame; the box frame is provided with a button position; the upper cover is provided with a fastener adapted with the button position; and an extending block is forward extended at one side of the upper cover where the fastener is arranged.

As an improvement of the present invention, the lock catch assemblies are connecting rod locks arranged on the front end of the roller shutter; and the lock bodies of the connecting rod locks are pressed so that locking rods on both sides of the lock bodies of the connecting rod locks can be respectively abutted against the guide slot on the corresponding side of the frame or leave the guide slot on the corresponding side.

As an improvement of the present invention, the upper surface of the locking rod on the left side of the connecting rod lock is provided with steps; and the lower surface of the locking rod on the right side of the connecting rod lock is provided with steps.

As an improvement of the present invention, each lock body is provided with a lock hole for back locking the lock catch assembly.

As an improvement of the present invention, the rolling and unrolling assembly comprises a roller shutter box, a first turntable and a second turntable arranged on both sides of the roller shutter box, and a rotating shaft arranged between the first turntable and the second turntable; the rotating shaft is connected with a fixed end of the roller shutter; the guide turntable comprises a chassis, a central hole arranged in the center of the chassis and used for installing a bearing of the rotating shaft, and a plurality of communicated roller shutter slots arranged on the chassis around the central hole; the radius of the central hole is R; a distance between two side walls of each roller shutter slot is K; the outer side wall of each roller shutter slot is connected with the inner side wall of each roller shutter slot; the projections of the connected side walls of the roller shutter on the chassis form Archimedes spiral using the center of a circle of the central hole as an origin, using the radius R of the central hole as an initial length unit and using K as a thread pitch; a spiral curve of the roller shutter slot ends on one side of the chassis and forms the roller shutter slot inlet for access of the roller shutter; and when the thickness of the roller shutter is Dmm, the thread pitch K=D+2 mm.

Compared with the prior art, the roller shutter for an automobile in the present invention has the following advantages:

1. In the roller shutter for the automobile in the present invention, the positioning ruler of the pre-positioning installation mechanism enables the front distance and the rear distance of the two guide slots to be equal and to be adapted to the width of the roller shutter. Then, the regulating bolt penetrates through the regulating hole on the connecting wall and spins on the connecting plate; and the two guide slots are pre-positioned and kept in balance. Subsequently, when the two guide slots are locked to the frame, because of the limiting of the regulating bolt, the distance between the front and rear ends of the guide slot will not be different due to different locking forces.

2. In the roller shutter for the automobile in the present invention, the positioning and locking mechanism is used with the roller shutter for the automobile; and the regulating bolt first locates the distance between the connecting wall of the guide slot and the connecting plate of the frame. When the locking bolt penetrates through the locking screw holes on the front fixing component and the rear fixing component so that the front fixing component and the connecting wall are locked together, the rear fixing component and the connecting plate are locked together and the front fixing component and the rear fixing component are locked together, because of the positioning effect of the regulating bolt, the locking piece can only lock the front fixing component with the connecting wall, lock the rear fixing component with the connecting plate and lock the front fixing component with the rear fixing component within the setting range of the regulating bolt. Each locking position of the whole guide slot is positioned by the regulating bolt and then locked by the locking piece. Each guide slot can be made parallel to the frame, so that the two guide slots remain parallel.

3. In the roller shutter for the automobile in the present invention, both sides of the arc bottom surface of the roller shutter are in linear contact with the slide rail; the roller shutter slides on the slide rail through the arc bottom surface which is in linear contact with the slide rail through each roller shutter plate; Compared with the switching of the roller shutter by rotation along the guide rail through the bearing, the switching of the roller shutter by the frictional force between the roller shutter plate and the slide rail greatly reduces the cost of the roller shutter. At the same time, compared with surface contact, the linear contact has smaller contact surface and minimizes the frictional force in the sliding process, making the switching process of the roller shutter smoother and more effortless. In addition, the slide rail is arranged in the guide slot. The guide slot can not only limit the roller shutter so that the switching of the roller shutter is not affected due to offset caused by uneven stress, but also avoid increasing the frictional force in the sliding process caused by outside dust which falls on the slide rail or affecting the switching smoothness of the roller shutter caused by foreign matter.

4. In the roller shutter for the automobile in the present invention, the roller shutter slot of the turntable solves the mode of rolling the roller shutter using a roller in the traditional product, reduces the cost of the turntable, and facilitates the rolling of the roller shutter. At the same time, the structure can also reduce the weight and the cost of the whole product.

5. In the roller shutter for the automobile in the present invention, in the process of unrolling the roller shutter or rolling the roller shutter, the lock catch assembly can be pressed at any time according to the size of the required compartment opening so that the lock catch assembly is simultaneously locked with the guide slots on both sides to stop unrolling or rolling the roller shutter. Locking and positioning are conducted at any time, which is high in flexibility and high in freedom. Because of the effect of the fastener, the roller shutter and the guide slot are locked and the roller shutter will not be unrolled randomly, so the roller shutter is safe and reliable.

### DESCRIPTION OF DRAWINGS

FIG. 1 is a structural schematic diagram of a roller shutter for an automobile of the present invention;

FIG. 2 is a structural schematic diagram of FIG. 1 after a roller shutter is removed;

FIG. 3 is a structural schematic diagram of a roller shutter in FIG. 1;

FIG. 4 is a structural schematic diagram of a guide slot in FIG. 1;

FIG. 5 is a structural schematic diagram of a roller shutter plate in FIG. 3;

FIG. 6 is a structural schematic diagram of a slide block in FIG. 3;

FIG. 7 is a structural schematic diagram of FIG. 6 in another direction;

FIG. 8 is a structural schematic diagram of a pre-positioning installation assembly;

FIG. 9 is a connection relationship diagram when pre-positioning installation assemblies and positioning and locking assemblies connect a guide slot and a frame;

FIG. 10 is a structural schematic diagram of a positioning and locking assembly in FIG. 1;

FIG. 11 is a structural schematic diagram of a guide turntable in FIG. 2;

FIG. 12 is a main view of FIG. 11;

FIG. 13 is a structural schematic diagram of one embodiment of a lock catch assembly in FIG. 1;

FIG. 14 is a structural schematic diagram of a first lock catch assembly;

FIG. 15 is a structural schematic diagram of FIG. 14 in another direction;

FIG. 16 is a structural schematic diagram of another embodiment of a lock catch assembly in FIG. 1;

FIG. 17 is an enlarged view of A in FIG. 16;

FIG. 18 is a structural schematic diagram of a lock box cover in FIG. 13;

FIG. 19 is a structural schematic diagram of an upper cover in FIG. 18; and

FIG. 20 is a structural schematic diagram of a lock box in FIG. 13.

In the figures: 1. guide slot; 11. connecting wall; 12. positioning block; 13. slide rail; 2. roller shutter; 21. first roller shutter plate; 211. connecting hole; 212. clamping groove; 213. reinforcing rib; 214. rubber slot; 215. roller shutter hinge; 22. slide block; 221. connecting block; 222. avoiding slot; 223. clamping block; 23. rubber strip; 24. second roller shutter plate; 3. lock catch assembly; 31. lock body; 32. lock hook; 33. locking rod; 331. step; 34. rubber column; 35. lock hole; 36. installing hole; 37. lock box; 371. assembling hole; 38. lock box cover; 381. box frame; 3811. button position; 382. upper cover; 3821. fastener; 3822. extending block; 4. rolling and unrolling assembly; 41. roller shutter box; 42. first turntable; 421. chassis; 422. central hole; 423. roller shutter slot; 424. screw hole; 425. groove; 426. avoiding arc; 427. fixing hole; 428. bayonet lock; 429. roller shutter slot inlet; 43. rotating shaft; 44. second turntable; 5. pre-positioning installation assembly; 51. positioning ruler; 53. regulating bolt; 6. positioning and locking assembly; 61. front fixing component; 62. rear fixing component; 63. locking bolt; 64. gasket; and 7. connecting plate

### DETAILED DESCRIPTION

The present invention will be further described in detail below in combination with the drawings and preferred embodiments.

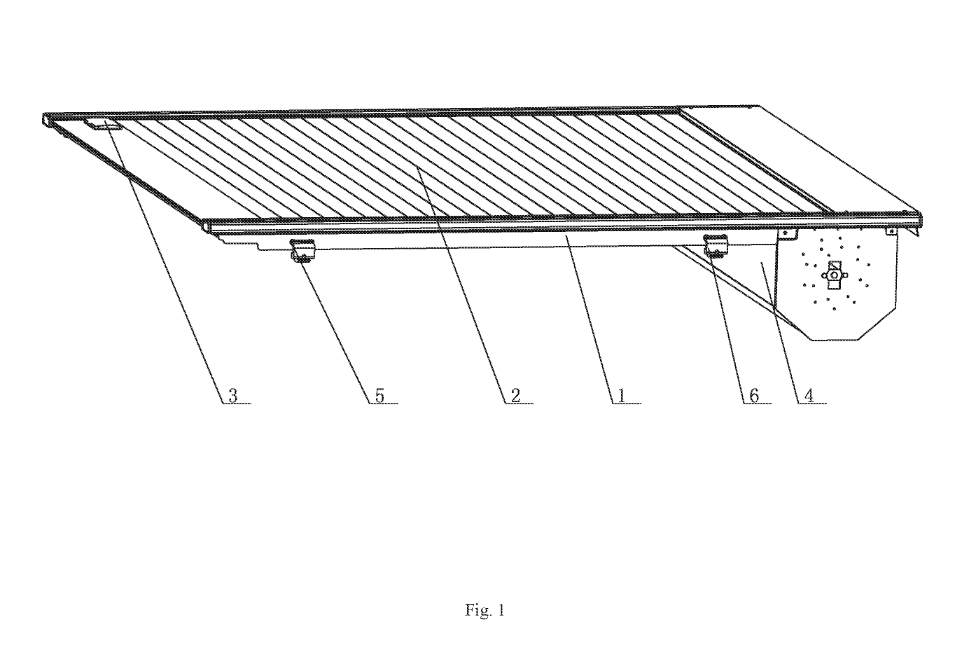

As shown in FIG. 1 to FIG. 20, a roller shutter for an automobile is provided. The roller shutter 2 for an automobile comprises guide slots 1 arranged on both sides of a frame, a roller shutter 2 that slides between the two guide slots 1, a lock catch assembly 3 arranged on the roller shutter 2 and locked with the guide slots 1 on both sides, a rolling and unrolling assembly 4 for rolling and unrolling the roller shutter 2, a plurality of groups of pre-positioning installation assemblies 5 used for enabling the two guide slots 1 to keep parallel and positioning and locking assemblies 6 used with the pre-positioning installation assemblies 5 and connecting the guide slots 1 with the frame. Positioning blocks 12 are arranged symmetrically at the front end of two guide slots 1. The movable end of the roller shutter 2 extends downwards and has a limiting sheet. In the unrolling of the roller shutter 2, the positioning blocks 12 may play a limiting effect.

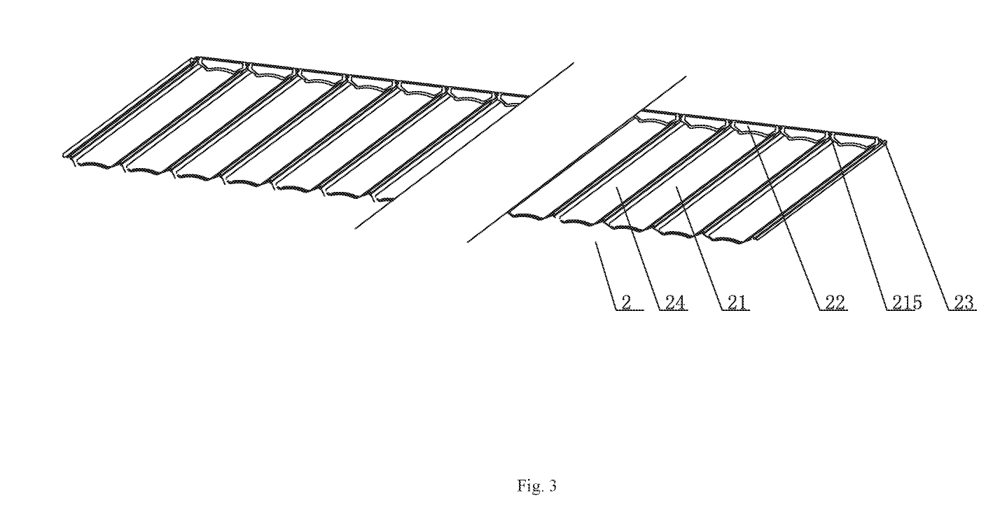

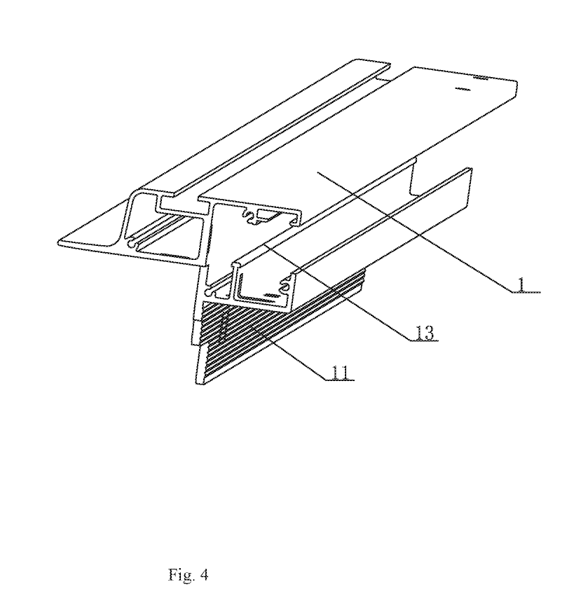

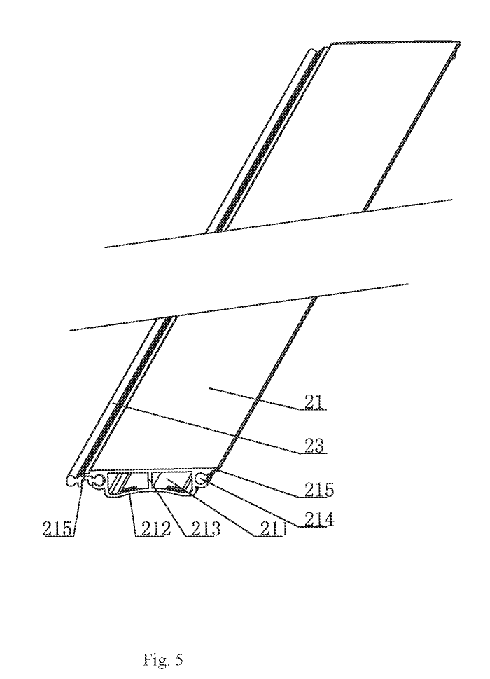

As shown in FIG. 3, FIG. 4 and FIG. 5, each guide slot 1 extends downward and has a connecting wall 11; the guide slot 1 is connected with a connecting plate 7 arranged on the frame through the connecting wall 11; a slide rail 13 is arranged in the guide slot 1; the roller shutter 2 is formed by mutually connecting a plurality of first roller shutter plates 21 and second roller shutter plates 24; rubber slots 214 are arranged on the left sides and the right sides of the first roller shutter plates 21 and the second roller shutter plates 24; and the first roller shutter plates 21 and the second roller shutter plates 24 are connected through rubber strips 23 adapted with the rubber slots 214. The bottom surface of each roller shutter plate 21 is arched upward to form an arc; both sides of the arc bottom surface are in linear contact with the slide rail 13; and the roller shutter 2 slides on the slide rail 13 through the arc bottom surface which is in linear contact with the slide rail 13 through each roller shutter plate 21.

Preferably, roller shutter hinges 215 are respectively arranged on the left sides and the right sides of the first roller shutter plates 21 and the second roller shutter plates 24. The first roller shutter plates 21 and the second roller shutter plates 24 are connected through the roller shutter hinges 215 to make a seal connection between the roller shutter plates 21. The surface of the roller shutter 2 is made into a plane as much as possible. At the same time, the gap at the connection is reduced to ensure waterproof performance of the roller shutter 2 in the use process and prevent rainwater from leaking into the compartment. This structure can ensure sealing performance. The interface of the rubber strip 23 has good extensibility and wear resistance, so that the life of the product can be prolonged.

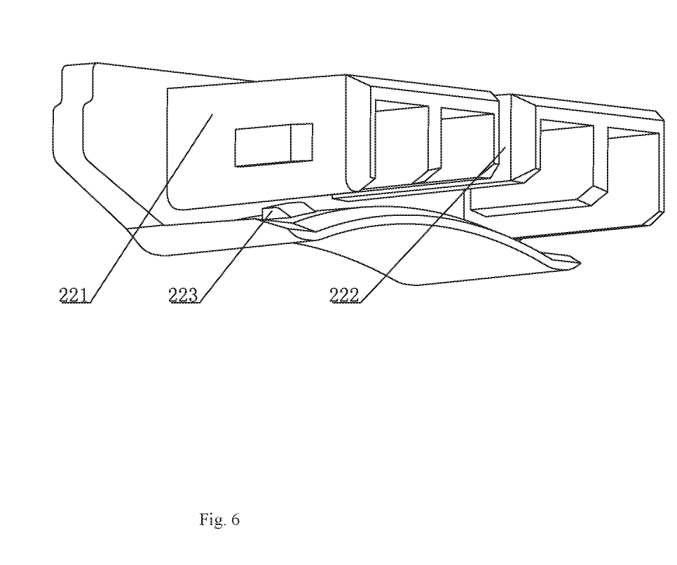

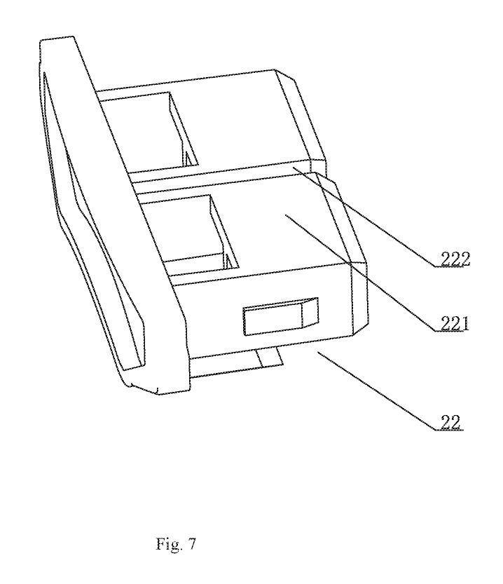

Preferably, as shown in FIG. 3, FIG. 6 and FIG. 7, slide blocks 22 are arranged on the front side and the rear side of each roller shutter plate 21; the bottom surfaces of the slide blocks 22 are arc surfaces adapted to the arc bottom surfaces of the roller shutter gates 21; and the roller shutter 2 slides on the slide rail 13 of the guide slot 1 through the slide blocks 22 arranged on each roller shutter plate 21. Because the roller shutter 2 is relatively wide and flexible, it is difficult to keep the arc surface of each roller shutter plate 21 consistent if the arc surface is processed on the bottom of the whole roller shutter plate 21. It is also possible in the assembly process that the arc surfaces on both sides cannot come into contact with the slide rail 13 due to flexible deformation of the roller shutter plate 21, which may affect the switching of the roller shutter 2. The above problem can be solved by adding the slide blocks 22 on both ends of the roller shutter plate 21. Because the slide blocks 22 are difficult to deform and easy to attach to the slide rail 13, the switching process of the roller shutter 2 is smooth.

Preferably, as shown in FIG. 5, FIG. 6 and FIG. 7, each slide block 22 is provided with a connecting block 221; each roller shutter plate 21 is provided with a connecting hole 211; the connecting block 221 of the slide block 22 is clamped into the connecting hole 211 and the bottom surface of the slide block 22 is bucked on the bottom surface of the roller shutter plate 21.

Preferably, as shown in FIG. 5, FIG. 6 and FIG. 7, the upper surface of the bottom surface of the slide block 22 is provided with a clamping block 223; and the roller shutter plate 21 is provided with a clamping groove 212 adapted with the clamping block 223. In the process that the connecting block 221 is inserted into the connecting hole 211, the clamping block 233 is matched with the clamping groove 212 so that the connection relationship between the slide block 22 and the roller shutter plate 21 is more firm.

Preferably, as shown in FIG. 5, connecting holes 211 on the front side and the rear side of the roller shutter plate 21 are communicated. The connecting holes 211 make the roller shutter plate 21 hollow, so as to reduce the weight of the roller shutter 2 and also save the cost.

Preferably, as shown in FIG. 5, reinforcing ribs 213 are arranged in the connecting holes 211, and avoiding slots 222 adapted to the reinforcing ribs 213 are formed in the connecting block 221 of the corresponding slide block 22. The reinforcing ribs 213 can increase the strength of the roller shutter plate 21. At the same time, when the slide block 22 is installed on the roller shutter plate 21, the avoiding slots 222 can avoid the reinforcing ribs 213.

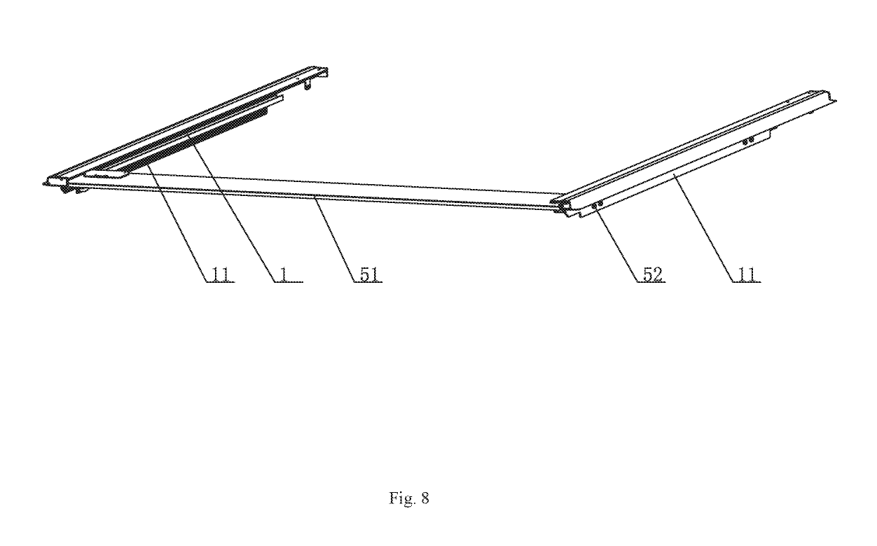

As shown in FIG. 8, the pre-positioning installation assemblies 5 comprise a positioning ruler 51 used for enabling the front distance and the rear distance of the two guide slots 1 to be equal, and a regulating bolt 52 for keeping the two guide slots 1 parallel; a regulating hole adapted with the regulating bolt 52 is formed in the connecting wall 11; the length of the positioning ruler 51 is adapted with the width of the roller shutter 2; and the regulating bolt 52 on each guide slot 1 penetrates through the regulating hole and spins on the connecting plate 7 on the frame.

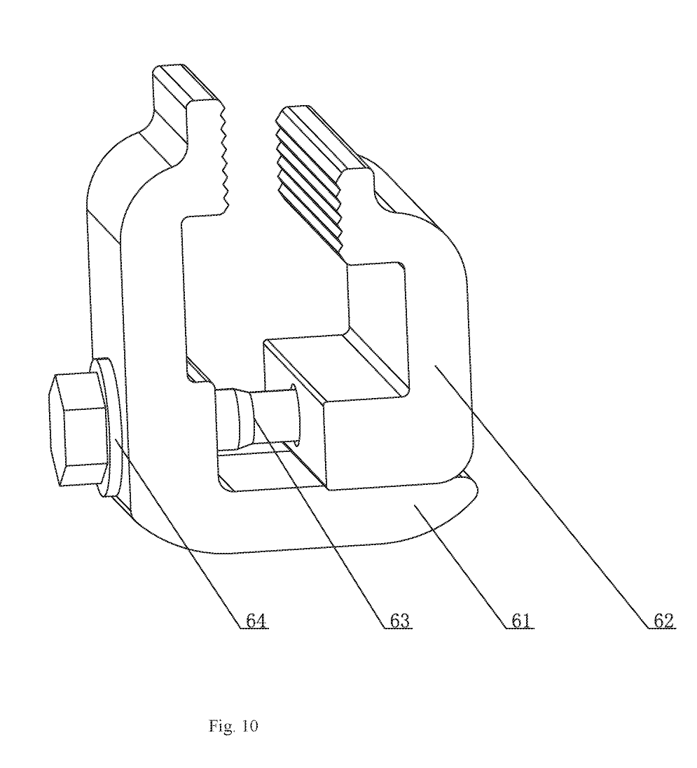

As shown in FIG. 10, the positioning and locking assemblies 6 comprise a front fixing component 61, a rear fixing component 62 and a locking bolt 63; locking screw holes 424 are formed in the front fixing component 61 and the rear fixing component 62; the front fixing component 61, the connecting wall 11, the connecting plate 7 and the rear fixing component 62 are arranged in sequence; the front fixing component 61 is arranged between two regulating bolts 52; the regulating bolts 52 penetrate through the connecting wall 11 and spin on the connecting plate 7; the locking bolt 63 penetrates through the locking screw holes 424 in the front fixing component 61 and the rear fixing component 62 so that the front fixing component 61 and the connecting wall 11 are locked together, the rear fixing component 62 and the connecting plate 7 are locked together and the front fixing component 61 and the rear fixing component 62 are locked together.

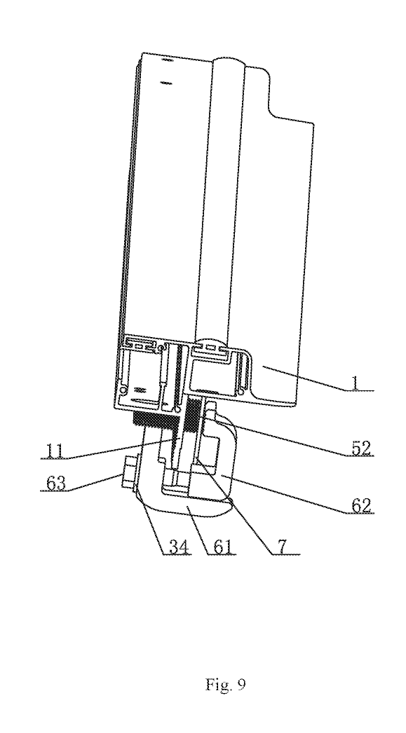

Preferably, each guide slot 1 is at least provided with two regulating bolts 52; the front end and the rear end of each guide slot 1 are provided with at least one regulating bolt 52; and the regulating bolt 52 on each guide slot 1 is symmetrical with the regulating bolt 52 on the other guide slot 1. As shown in FIG. 9, when the guide slot 1 is installed, the rear distance of the guide slot 1 is adjusted with the positioning ruler 51, and the regulating bolts 52 are used for pre-positioning. Then, the positioning ruler 51 is moved so that the front distance of two guide slots 1 is adapted with the positioning ruler 51. Then, the regulating bolts 52 are used for pre-positioning. Because the front distance and the rear distance of the two guide slots 1 are adapted to the positioning ruler 51, the two guide slots 1 can be kept parallel. Because the length of the positioning ruler 51 is adapted with the width of the roller shutter 2, the distance between the two guide slots 1 is adapted with the width of the roller shutter 2 and the roller shutter 2 can be rolled or unrolled smoothly between the two guide slots 1.

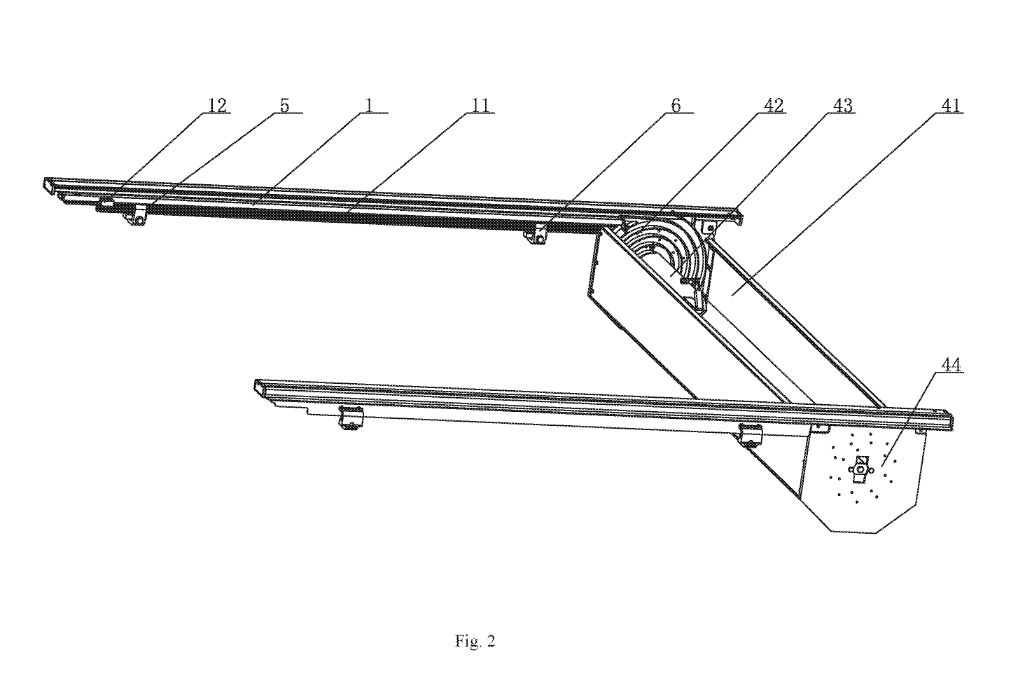

Preferably, as shown in FIG. 2, every two regulating bolts 52 are used with one positioning and locking assembly 6, which can ensure parallelism between the guide slot 1 and the frame after the positioning and locking assembly 6 is locked.

Preferably, as shown in FIG. 10, the front fixing component 61 and the rear fixing component 62 are in L shape; and when the front fixing component 61 and the rear fixing component 62 are locked, the rear fixing component 62 is pressed on the front fixing component 61, which is convenient for the locking bolt 63 to align the locking screw holes 424 on the front fixing component 61 and the rear fixing component 62 when the front fixing component 61 and the rear fixing component 62 are locked.

Preferably, as shown in FIG. 10, the contact surface between the front fixing component 61 and the connecting wall 11, and the contact surface between the rear fixing component 62 and the connecting piece are provided with skidproof grains. The contact surface between the connecting wall 11 and the front fixing component 61, and the contact surface between the connecting piece and the rear fixing component 62 are provided with skidproof grooves adapted with the skidproof grains. The locking of the front fixing component 61 and the connecting wall 11 and the locking of the rear fixing component 62 and the connecting piece are firmer.

Preferably, as shown in FIG. 10, a gasket 64 is arranged between the locking bolt 63 and the front fixing component 61. The locking of the front fixing component 61 and the rear fixing component 62 is former.

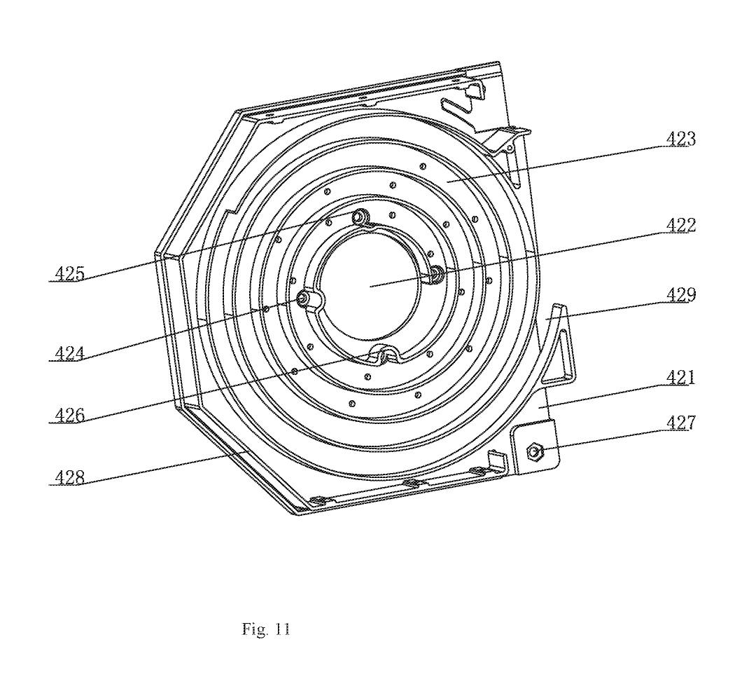

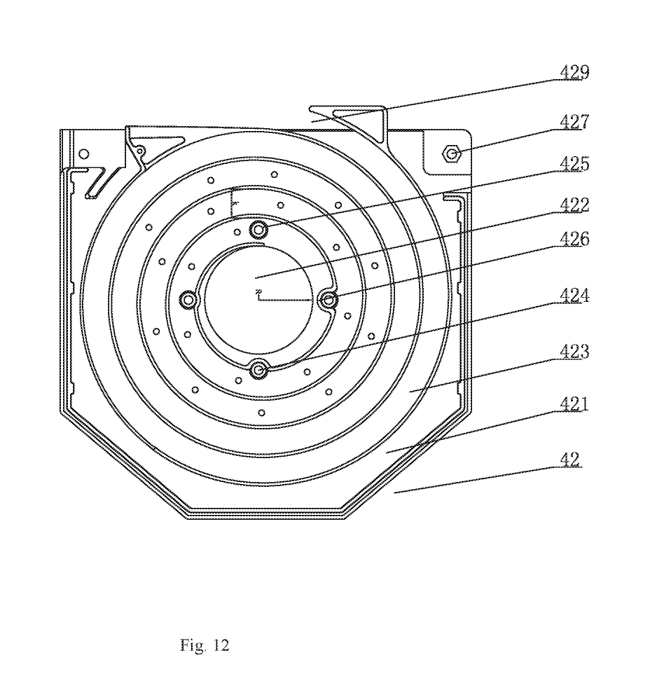

As shown in FIG. 2, FIG. 11 and FIG. 12, the rolling and unrolling assembly 4 comprises a roller shutter box 41, a first turntable 42, a second turntable 44, a fixing hole 427, a bayonet lock 428, a roller shutter slot 423 and a roller shutter slot inlet 429; one end of the roller shutter box 41 is provided with the first turntable 42, and the other end of the roller shutter box 41 is provided with the second turntable 44; a rotating shaft 43 positioned inside the roller shutter box 41 is arranged between the first turntable 42 and the second turntable 44; and the roller shutter 2 is arranged on the fixed connection between the rotating shaft 43 and a scroll 2. One end of the roller shutter slot 423 is provided with the roller shutter slot inlet 429; the bayonet lock 428 and the fixing hole 427 are arranged around the first turntable 42 and the second turntable 44; and the first turntable 32 and the second turntable 44 are fixed to the roller shutter box 41 through the fixing hole 427 and the bayonet lock 428.

Preferably, each of the first turntable 42 and the second turntable 44 comprise a chassis 421, a central hole 422 arranged in the center of the chassis 421 and used for installing a bearing of the rotating shaft 43, and a plurality of communicated roller shutter slots 423 arranged on the chassis 421 around the central hole 422; the radius of the central hole 422 is R; a distance between two side walls of each roller shutter slot 423 is K; the outer side wall of each roller shutter slot 423 is connected with the inner side wall of each roller shutter slot 423; the projections of the connected side walls of the roller shutter 2 on the chassis 421 form Archimedes spiral using the center of a circle of the central hole 422 as an origin, using the radius R of the central hole 422 as an initial length unit and using K as a thread pitch; a spiral curve of the roller shutter slot 423 ends on one side of the chassis 421 and forms the roller shutter slot inlet for access of the roller shutter 2; and when the thickness of the roller shutter 2 is Dmm, the thread pitch K=D+2 mm. There is only one layer of roller shutter 2 in each roller shutter slot 423, and each layer of roller shutter 2 is separated by the outer side wall of the roller shutter slot 423. Each layer is not affected by each other, so that rolling and unrolling are relatively smooth. When the thickness of the roller shutter 2 is Dmm, the thread pitch K=D+2 mm. A difference value of 2 mm is set between the thread pitch and the thickness of the roller shutter 2. This difference value not only can ensure small frictional force for smooth rolling or unrolling of the roller shutter 2, but also can minimize the size of the guide turntable under the requirement that the roller shutter 2 is sufficient to fully roll.

Preferably, D=15 mm and K=17 mm. In such thread pitch, it can not only ensure that the roller shutter 2 can be smoothly rolled into the roller shutter slot 423, but also ensure that the roller shutter 2 is smoothly rolled into the roller shutter slot 423. The frictional force can be reduced, and noise during rolling can also be reduced.

Preferably, 37 mm<R<40 mm. Under the condition that K=17 mm, the roller shutter 2 of 170 mm-260 mm can be fully rolled into the roller shutter slot 423 within 3-4 circles. Thus, the area of the guide turntable 42 is small enough.

Preferably, as shown in FIG. 12, the end of the side wall of the roller shutter slot 423 at the roller shutter slot inlet 429 is a smooth arc surface. During rolling, the smooth arc surface can guide the roller shutter 2 to enter the roller shutter slot 423 along the roller shutter slot inlet 429.

Preferably, as shown in FIG. 11 and FIG. 12, the periphery of the central hole 422 is provided with a screw hole 424 for fixing the bearing of the roller shutter 2 and the chassis 421, and the screw hole 424 forms a groove 425 on the upper surface of the chassis 421. When the bearing of the roller shutter 2 is fixed on the chassis 421, a screw cap can enter the groove 425 and does not protrude from the upper surface of the chassis 421, which will not affect the roller shutter 2 in the roller shutter slot 423.

Preferably, as shown in FIG. 12, the part of the roller shutter slot 423 projected onto the screw hole 424 is concave to the center of a circle of the central hole 422, so as to form an avoiding arc 426 for easy assembly.

Preferably, the side wall of the roller shutter slot 423 and the chassis 421 are formed integrally.

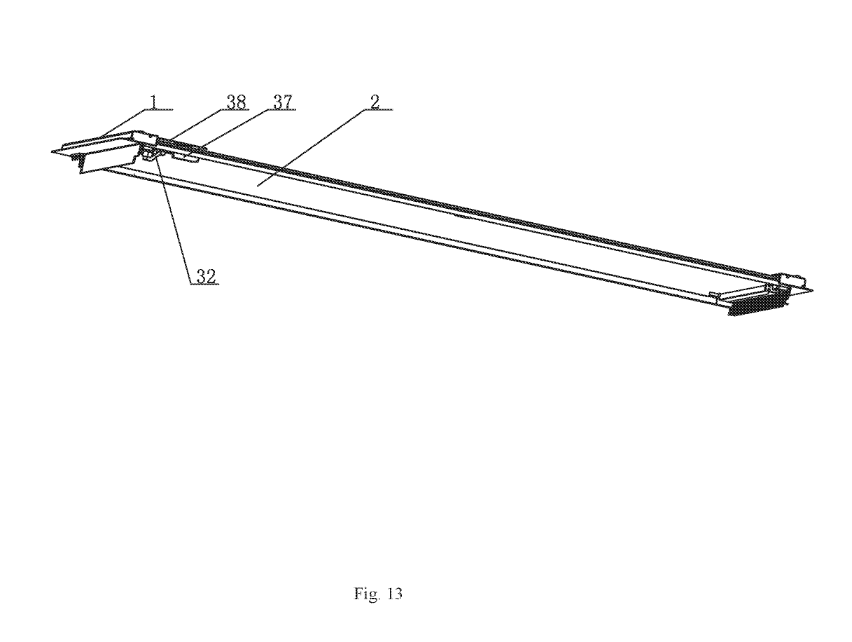

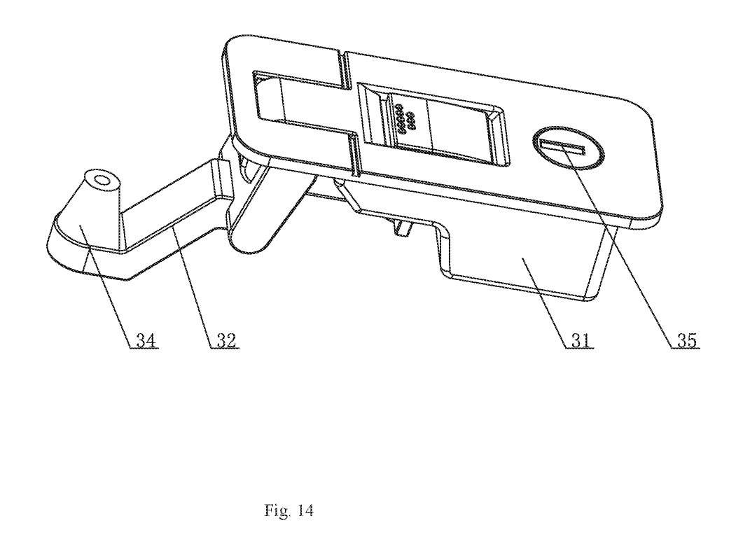

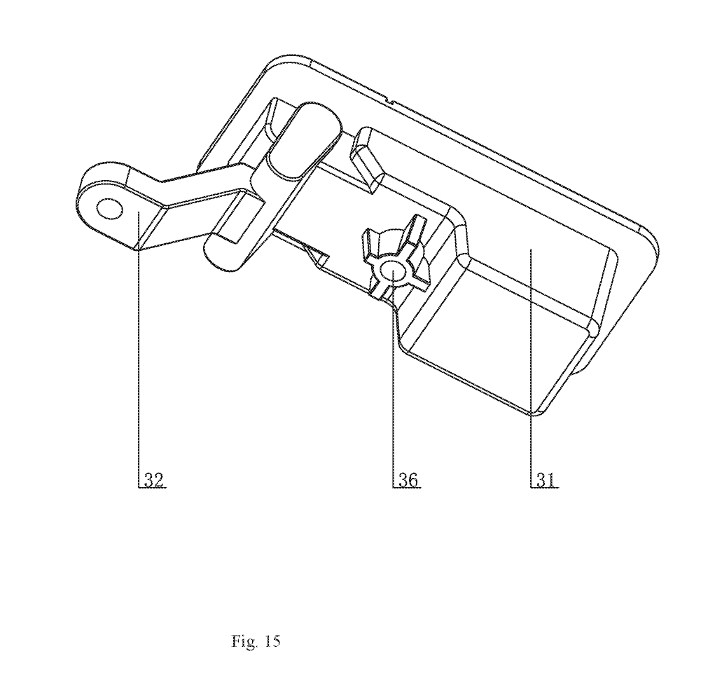

As shown in FIG. 13, FIG. 14 and FIG. 15, the lock catch assemblies 3 may be two spring locks with lock hooks 32 symmetrically arranged on both sides of the front end of the roller shutter 2; and lock bodies 31 of the spring locks are pressed so that the lock hooks 32 can extend to the guide slots 1 and fasten with the lower surfaces of the guide slots 1 or release the guide slots 1 and keep away from the lower surfaces of the guide slots 1.

Preferably, as shown in FIG. 14, the lock hooks 32 are provided with rubber columns 34. When the lock hooks 32 are pressed to the bottom surface of the guide slot 1 under the elastic force of a spring of the spring lock, the rubber columns 34 can disperse the impulse and play a protective role for the guide slot 1. At the same time, due to the greater resistance of rubber, the frictional force between the fastener and the guide slot 1 can also be increased, so as to lock the roller shutter 2 and the guide slot 1.

When the roller shutter 2 is required to stop unrolling or rolling, the lock bodies 31 of two spring locks are pressed at any time. The lock hook 32 on each spring lock extends to the guide slot 1 on the opposite side, and presses the rubber column 34 on the lock hook 32 to the lower surface of the guide slot 1 on the opposite side. When the roller shutter 2 is required to unroll or continuously roll, the lock bodies 31 of the two spring locks are pressed once again. The lock hooks 32 keep away from the lower surface of the guide slot 1, and the roller shutter 2 can be continuously rolled or unrolled.

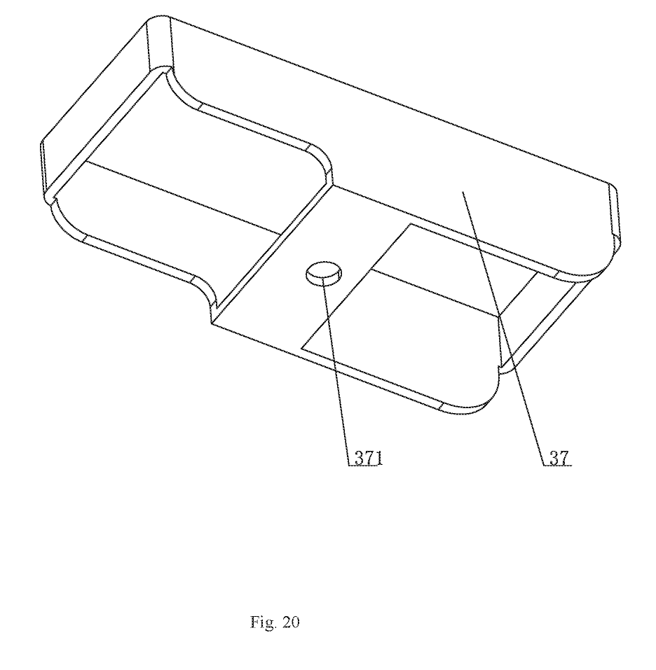

Preferably, as shown in FIG. 13, the lock catch assemblies 3 are arranged on the roller shutter 2 through lock boxes 37 adapted with the lock bodies 31 of the spring locks; and installing holes 36 are formed in the bottoms of the lock bodies 31 of the spring locks. As shown in FIG. 20, the lock boxes 37 are provided with assembling holes 371 adapted with the installing holes 36.

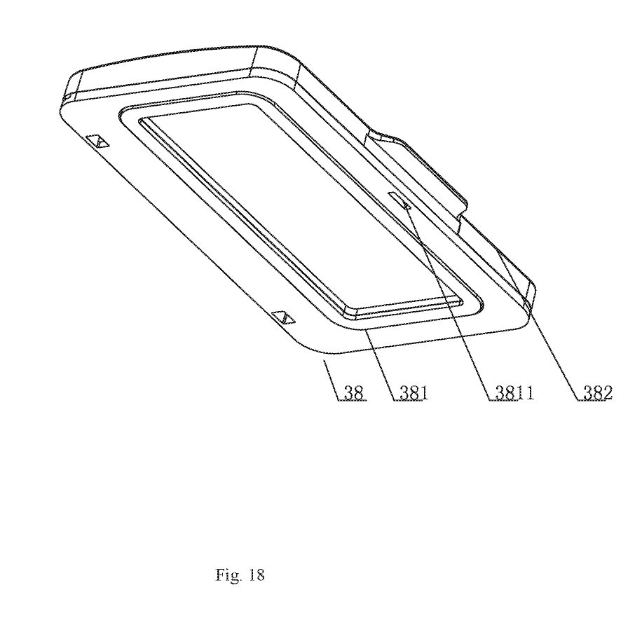

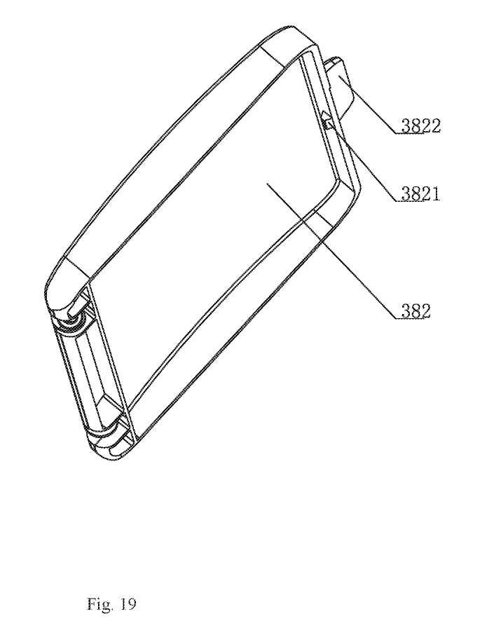

Preferably, the upper surface of the roller shutter 2 is provided with a lock box cover 38 for buckling the lock bodies 31 inside. As shown in FIG. 18 and FIG. 19, the lock box cover 38 is divided into a box frame 381 and an upper cover 382 pivoted with the box frame 381; the box frame 381 is provided with a button position 3811; the upper cover 382 is provided with a fastener 3821 adapted with the button position 3811; and when the lock catch assembly 3 is not used, the lock catch assembly 3 is locked inside through the lock box cover 38. When the lock catch assembly 3 needs to be operated, the upper cover 382 is opened for operation.

Preferably, as shown in FIG. 19, an extending block 3822 is forward extended at one side of the upper cover 382 where the fastener 3821 is arranged. When the upper cover 382 needs to be opened, the extending block 3822 is buckled up to open the upper cover 382.

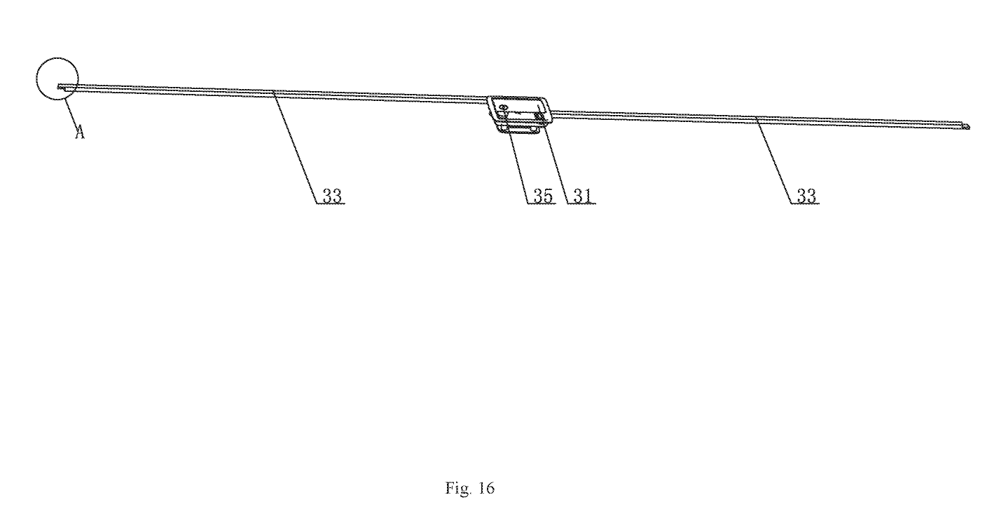

As shown in FIG. 16, the lock catch assemblies 3 may also be connecting rod locks arranged on the front end of the roller shutter 2; and the lock bodies 31 of the connecting rod locks are pressed so that locking rods 33 on both sides of the lock bodies 31 of the connecting rod locks can be respectively abutted against the guide slot 1 on the corresponding side of the frame or leave the guide slot 1 on the corresponding side.

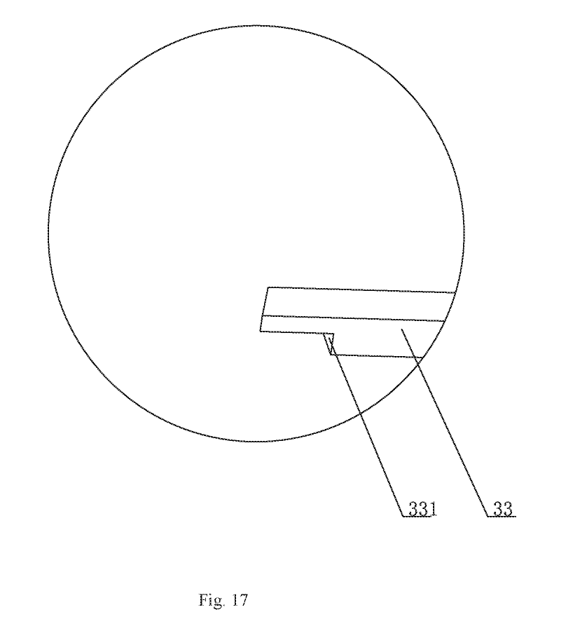

Preferably, as shown in FIG. 17, the upper surface of the locking rod 33 on the left side of the connecting rod lock is provided with steps 331; and the lower surface of the locking rod 33 on the right side of the connecting rod lock is provided with steps 331.

When the roller shutter 2 is required to stop unrolling or rolling, the lock body 31 of the connecting rod lock is pressed at any time. Two locking rods 33 of the lock body 31 extend to the guide slot 1 on the opposite side, and clamp the steps 331 to the guide slot 1 on the opposite side. When the roller shutter 2 is required to unroll or continuously roll, the lock body 31 of the connecting rod lock is pressed once again. Two locking rods 33 on both sides of the lock body 31 keep away from the guide slot 1, and the roller shutter 2 can be continuously rolled or unrolled. The lock body 31 is pressed so that the locking rods 33 on both sides of the lock body 31 can act at the same time.

Preferably, as shown in FIG. 16, the lock body 31 is provided with a lock hole 35 for back locking the lock catch assembly 3. After the roller shutter 2 is closed or opened as required, the lock catch assembly 3 will be back locked to avoid misoperation.

The above only describes preferred embodiments of the present invention and is not intended to limit the present invention. Any modification, equivalent replacement or improvement, etc. made within the spirit and the principle of the present invention shall be contained within the protection scope of the present invention.

What is claimed is:

1. A roller shutter for an automobile, comprising guide slots arranged on both sides of a frame, a roller shutter that slides between the two guide slots, a lock catch assembly arranged on the roller shutter and locked with the guide slots on both sides, a rolling and unrolling assembly for rolling and unrolling the roller shutter, a plurality of groups of pre-positioning installation assemblies used for enabling the two guide slots to keep parallel and positioning and locking assemblies used with the pre-positioning installation assemblies and connecting the guide slots with the frame,
wherein each guide slot extends downward and has a connecting wall; the guide slot is connected with a connecting plate arranged on the frame through the connecting wall; a slide rail is arranged in the guide slot; the roller shutter is formed by mutually connecting a plurality of roller shutter plates; rubber slots are arranged on the left side and the right side of each roller shutter plate; left and right roller shutter plates are connected through rubber strips adapted with the rubber slots; the bottom surface of each roller shutter plate is arched upward to form an arc; both sides of the arc bottom surface are in linear contact with the slide rail; the roller shutter slides on the slide rail through the arc bottom surface which is in linear contact with the slide rail through each roller shutter plate;
the pre-positioning installation assemblies comprise a positioning ruler used for enabling the front distance and the rear distance of the two guide slots to be equal, and a regulating bolt for keeping the two guide slots parallel; a regulating hole adapted with the regulating bolt is formed in the connecting wall; the length of the positioning ruler is adapted with the width of the roller shutter; the regulating bolt on each guide slot penetrates through the regulating hole and spins on the connecting plate on the frame;
the positioning and locking assemblies comprise a front fixing component, a rear fixing component and a locking bolt; locking screw holes are formed in the front fixing component and the rear fixing component; the front fixing component, the connecting wall, the connecting plate and the rear fixing component are arranged in sequence; the regulating bolt penetrates through the connecting wall and spins on the connecting plate; the locking bolt penetrates through the locking screw holes in the front fixing component and the rear fixing component so that the front fixing component and the connecting wall are locked together, the rear fixing component and the connecting plate are locked together and the front fixing component and the rear fixing component are locked together;
the rolling and unrolling assembly comprises a roller shutter box, a first turntable, a second turntable, a fixing hole, a bayonet lock, a roller shutter slot and a roller shutter slot inlet; one end of the roller shutter box is provided with the first turntable, and the other end of the roller shutter box is provided with the second turntable; the roller shutter box is provided with the roller shutter; the first turntable and the second turntable are provided with the roller shutter slot; one end of the roller shutter slot is provided with the roller shutter slot inlet; the bayonet lock and the fixing hole are arranged around the first turntable and the second turntable; and the first turntable and the second turntable are fixed to the roller shutter box through the fixing hole and the bayonet lock.

2. The roller shutter for an automobile according to claim 1, wherein the roller shutter comprises first roller shutter plates, second roller shutter plates, a roller shutter hinge, a rubber slot and a rubber strip; the roller shutter is provided with a plurality of the first roller shutter plates and the second roller shutter plates; the first roller shutter plates are connected with the second roller shutter plates through the roller shutter hinge; the rubber slot is arranged between the first roller shutter plates and the second roller shutter plates; and the rubber slot is provided with the rubber strip.

3. The roller shutter for an automobile according to claim 1, wherein slide blocks are arranged on the front side and the rear side of each roller shutter plate; the bottom surfaces of the slide blocks are arc surfaces adapted to the arc bottom surfaces of the roller shutter gates; and the roller shutter slides on the slide rail of the guide slot through the slide blocks arranged on each roller shutter plate.

4. The roller shutter for an automobile according to claim 3, wherein each slide block is provided with a connecting block; each roller shutter plate is provided with a connecting hole; the connecting block of the slide block is clamped into the connecting hole and the bottom surface of the slide block is bucked on the bottom surface of the roller shutter plate; the upper surface of the bottom surface of the slide block is provided with a clamping block; and the roller shutter plate is provided with a clamping groove adapted with the clamping block.

5. The roller shutter for an automobile according to claim 1, wherein the front end and the rear end of each guide slot are provided with at least two regulating bolts; the regulating bolt on each guide slot is symmetrical with the regulating bolt on the other guide slot; and every two regulating bolts are used with one positioning and locking assembly.

6. The roller shutter for an automobile according to claim 5, wherein the front fixing component is arranged between two regulating bolts.

7. The roller shutter for an automobile according to claim 6, wherein the front fixing component and the rear fixing component are in L shape; and when the front fixing component and the rear fixing component are locked, the rear fixing component is pressed on the front fixing component.

8. The roller shutter for an automobile according to claim 1, wherein the lock catch assemblies are two spring locks with lock hooks symmetrically arranged on both sides of the front end of the roller shutter; and lock bodies of the spring locks are pressed so that the lock hooks can extend to the guide slots and fasten with the lower surfaces of the guide slots or release the guide slots and keep away from the lower surfaces of the guide slots.

9. The roller shutter for an automobile according to claim 8, wherein the lock hooks are provided with rubber columns.

10. The roller shutter for an automobile according to claim 9, wherein the lock catch assemblies are arranged on the roller shutter through lock boxes adapted with the lock bodies of the spring locks; installing holes are formed in the bottoms of the lock bodies of the spring locks; and the lock boxes are provided with assembling holes adapted with the installing holes.

11. The roller shutter for an automobile according to claim 10, wherein the upper surface of the roller shutter is provided with a lock box cover for bucking the lock bodies inside; the lock box cover is divided into a box frame and an upper cover pivoted with the box frame; the box frame is provided with a button position; the upper cover is provided with a fastener adapted with the button position; and an extending block is forward extended at one side of the upper cover where the fastener is arranged.

12. The roller shutter for an automobile according to claim 1, wherein the lock catch assemblies are connecting rod locks arranged on the front end of the roller shutter; and the lock bodies of the connecting rod locks are pressed so that locking rods on both sides of the lock bodies of the connecting rod locks are respectively abutted against the guide slot on the corresponding side of the frame or leave the guide slot on the corresponding side.

13. The roller shutter for an automobile according to claim 12, wherein the upper surface of the locking rod on the left side of the connecting rod lock is provided with steps; and the lower surface of the locking rod on the right side of the connecting rod lock is provided with steps.

14. The roller shutter for an automobile according to claim 8, wherein each lock body is provided with a lock hole for back locking the lock catch assembly.

15. The roller shutter for an automobile according to claim 1, wherein the rolling and unrolling assembly comprises a roller shutter box, a first turntable and a second turntable arranged on both sides of the roller shutter box, and a rotating shaft arranged between the first turntable and the second turntable; the rotating shaft is connected with a fixed end of the roller shutter; the guide turntable comprises a chassis, a central hole arranged in the center of the chassis and used for installing a bearing of the rotating shaft, and a plurality of communicated roller shutter slots arranged on the chassis around the central hole; the radius of the central hole is R; a distance between two side walls of each roller shutter slot is K; the outer side wall of each roller shutter slot is connected with the inner side wall of each roller shutter slot; the projections of the connected side walls of the roller shutter on the chassis form Archimedes spiral using the center of a circle of the central hole as an origin, using the radius R of the central hole as an initial length unit and using K as a thread pitch; a spiral curve of the roller shutter slot ends on one side of the chassis and forms the roller shutter slot inlet for access of the roller shutter; and when the thickness of the roller shutter is Dmm, the thread pitch K=D+2 mm.
